(19) United States
(12) Patent Application Publication
(10) Pub. No.: US 2023/0103025 A1
(43) Pub. Date: Mar. 30, 2023

(54) METHODS AND SYSTEMS FOR PRODUCTION OF FATTY ACID ESTERS OF POLYOLS

(71) Applicant: CARGILL, INCORPORATED, Wayzata, MN (US)

(72) Inventor: Jeff ADDY, Goodyear, AZ (US)

(73) Assignee: CARGILL, INCORPORATED, Wayzata, MN (US)

(21) Appl. No.: 17/907,139

(22) PCT Filed: Mar. 30, 2021
(86) PCT No.: PCT/US2021/024929

§ 371 Date: Sep. 23, 2022

Related U.S. Application Data
(60) Provisional application No. 63/002,234, filed on Mar. 30, 2020.

(51) Int. Cl. C11C 3/06

(52) U.S. Cl. CPC C11C 3/06

(57) ABSTRACT

Implementations of a process for forming esters of polyols may include mixing a polyol with a triglyceride in a reactor at a 2.5-6:1 molar ratio of polyol to triglyceride to form an input; mixing the input with isopropanol to form a diluted input; mixing a catalyst with the diluted input; and heating and agitating the diluted input to form a product including monoesters of the triglyceride and the polyol.

### CROSS REFERENCE TO RELATED APPLICATIONS

This document claims the benefit of the filing date of U.S. Provisional Patent Application 63/002,234, entitled “Methods and Systems for Production of High Purity Fatty Acid Monoesters of Polyols” to Jeff Addy which was filed on Mar. 30, 2020, the disclosure of which is hereby incorporated entirely herein by reference.

### BACKGROUND

### 1. Technical Field

Aspects of this document relate generally to processes for forming esters. More specific implementations involve processes for forming fatty acid esters.

### 2. Background

Esters include a wide variety of compounds that include two carbon groups linked by an ester group. Various fatty acid esters of glycerol are referred to as glycerides.

### SUMMARY

Implementations of a process for forming esters of polyols may include mixing a polyol with a triglyceride in a reactor at a 2.5-6:1 molar ratio of polyol to triglyceride to form an input; mixing the input with isopropanol to form a diluted input; mixing a catalyst with the diluted input; and heating and agitating the diluted input to form a product including monoesters of the triglyceride and the polyol.

Implementations of a process for forming esters of polyols may include one, all, or any of the following:

The monoesters may be between 30% to 95% by weight of the product.

The catalyst may be between 0.2% to 0.7% by weight of the diluted input.

The catalyst may be one of sodium methoxide, sodium hydroxide, potassium hydroxide, calcium carbonate, para-toluene sulfonic acid, hydrochloric acid, sulfuric acid, or any combination thereof.

The process may include forming a soap using the catalyst to solubilize the polyol, triglyceride, and isopropanol.

The polyol may be one of glycerol or a polyglycerol.

Implementations of a process for forming esters of polyols may include mixing a polyol with a triglyceride in a reactor at a 2.5-6:1 molar ratio of polyol to triglyceride to form an input; mixing the input with a solvent to form a diluted input; mixing a fatty acid salt with the diluted input to form a prepared input mixing a catalyst with the prepared input; and heating and agitating the prepared input to form a product including monoesters of the triglyceride and the polyol.

Implementations of a process for forming esters of polyols may include one, all, or any of the following:

The monoesters may be between 30% to 95% by weight of the product.

The catalyst may be between 0.2% to 0.7% by weight of the prepared input.

The catalyst may be one of sodium methoxide, sodium hydroxide, potassium hydroxide, calcium carbonate, para-toluene sulfonic acid, hydrochloric acid, sulfuric acid, or any combination thereof.

The process may include forming a soap using the catalyst to solubilize the polyol, triglyceride, and isopropanol.

The polyol may be glycerol or a polyglycerol.

The fatty acid salt may be sodium oleate and a concentration of the fatty acid salt in the prepared input may be 250 ppm after mixing.

Implementations of a process for forming esters of polyols may include mixing a polyol with a fatty acid in a reactor at a 2.5-6:1 molar ratio of polyol to fatty acid to form an input; mixing the input with a solvent to form a diluted input; mixing a base with the diluted input to form a saponified input; mixing a catalyst with the saponified input, and heating and agitating the saponified input to form a product including monoesters of the fatty acid and the polyol.

Implementations of a process for forming esters of polyols may include one, all, or any of the following:

The monoesters may be between 30% to 95% by weight of the product.

The catalyst may be between 0.2% to 0.7% by weight of the saponified input.

The catalyst may be one of sodium methoxide, sodium hydroxide, potassium hydroxide, calcium carbonate, para-toluene sulfonic acid, hydrochloric acid, sulfuric acid, or any combination thereof.

The polyol may be glycerol or a polyglycerol.

The base may be sodium hydroxide and the concentration of a fatty acid salt in the saponified input may be 250 ppm after mixing.

Mixing the polyol with the fatty acid further may include mixing a triglyceride with the polyol and the fatty acid and the product may include monoesters of the fatty acid, the triglyceride, and the polyol.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a chromatograph of the components of a product formed from cocoa butter and glycerol with isopropanol as the solvent with sodium methoxide as a catalyst showing the composition of the esters therein according to Example 3 herein;

FIG. 2 is a chromatograph of the components of a product formed from hydrogenated sunflower oil and glycerol with isopropanol as the solvent with para-toluene sulfonic acid as a catalyst showing the composition of the esters therein according to Example 4 herein;

FIG. 3 is a chromatograph of the components of a product formed from hydrogenated sunflower oil and glycerol with isopropanol as the solvent. Sodium oleate was added prior to addition of with para-toluene sulfonic acid as a catalyst showing the composition of the esters therein according to Example 6 herein;

FIG. 4 is a chromatograph of the components of a product formed from hydrogenated sunflower oil and glycerol with isopropanol as the solvent with sodium methoxide as a catalyst showing the composition of the esters therein according to Example 7 herein.

### DESCRIPTION

This disclosure, its aspects and implementations, are not limited to the specific components, assembly procedures or method elements disclosed herein. Many additional components, assembly procedures and/or method elements known in the art consistent with the intended processes and systems for forming fatty acid esters of polyols will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such fatty acid esters of polyols, and implementing components and methods, consistent with the intended operation and methods.

Fatty acid esters have been formed using alcohols such as glycerol, butanol, or hexanol. A process limited to monoglyceride products using t-butanol as a solvent is described in U.S. Pat. No. 7,531,677 to Choo et al., entitled “High purity palm monoglycerides,” issued May 12, 2009, the disclosure of which is hereby incorporated entirely by reference. Another example also employing t-butanol may be found that the process described in U.S. Pat. No. 2,789,119 to Bernard Thomas Dudley Sully, entitled “Production of fatty acid monoglycerides,” issued Apr. 16, 1957, the disclosure of which is hereby incorporated entirely herein by reference. Various process implementations disclosed herein may utilize less expensive solvents that butanol, t-butanol, or hexanol such as, by non-limiting example, isopropanol, ethanol, methanol, and other lower cost solvents. The methods disclosed herein utilize isopropyl alcohol (isopropanol) as a solvent while being able to produce high monoester conversion with glycerol as well as higher order polyols. These higher order polyols may include, by non-limiting example, polymers of glycerol referred to as polyglycerols, sugar monomers, sorbitol, erythritol, glucose, or any other chemical components comprising multiple alcohol groups. As used herein, polyglycerol is a polymerization product of vegetable derived glycerol that is formed to have a mean desired specific chain length at a particular chain length value. For example, polyglycerols can be in units of 2-10 with polyglycerol-3 being among the most common. The polyglycerol compositional distribution follows a Gaussian curve with the polymer chain lengths with the preferred polymeric order for a particular polyglycerol listed as the primary component (i.e. polyglycerol-3 has three units as the center of the Gaussian curve of polymer chain lengths) while other chain lengths are represented in the polyglycerol as minor components distributed according to the Gaussian distribution (polyglycerol 4, 6, 9, etc.).

In various process implementations, the use of glycerol and polyglycerol esters may be attractive due to their lower cost and abundance in the marketplace. However, the disclosed method can be used with many alternative polyols to produce equivalent results like those disclosed herein for forming monoesters. Also, in various implementations, the methods disclosed herein also may be used with t-butanol to produce monoesters at surprisingly high conversions at surprisingly high reaction rates. In various implementations, the inclusion of a fatty acid salt as an input in the reaction prior to the introduction of a catalyst (or the formation thereof through addition of a base) surprisingly increases the rate and/or the conversion of the feedstock to monoesters formation. The increased rate of monoester formation confirms the proposed reaction mechanism.

Various products disclosed in this document may be used as emulsifiers.

In various implementations of the method, the inputs may be a polyol and a triglyceride. In other implementations of the method, the inputs may be a polyol and a fatty acid. In yet other implementations of the method, the inputs may be a polyol, fatty acid, and a triglyceride. Where two inputs are utilized, the polyol and triglyceride/fatty acid may be mixed in a reactor in a 2.5-6.0:1 molar ratio. The molar ratio of the oil to polyol is dependent on the amount of hydroxyl groups present in the polyol and desired monoester content. Where three inputs are utilized, the polyol, the fatty acid, and the triglyceride may be mixed in a reactor in a 2.5-6.0:1:0.33 molar ratio, respectively.

Following mixing of the inputs to form an input, the input is then diluted with a solvent to form a diluted input. In various implementations, the solvent may be t-butanol. In other implementations, the solvent may be isopropanol. In various implementations the isopropanol may be anhydrous isopropanol. In various implementations where anhydrous isopropanol is used, the isopropanol may total 5-30% by weight of the diluted input with 15%-25% by weight used in particular implementations.

In some implementations, the reaction is catalyzed by adding to the diluted input 0.05%-0.7% of a catalyst by weight of the diluted input. In particular implementations, the reaction may be catalyzed using, by non-limiting example, sodium methoxide, alkali catalysts, sodium hydroxide, potassium hydroxide, calcium carbonate any combination thereof, or any other base. In other implementations, the reaction may be catalyzed using, by non-limiting example, alkylsulfonic acids, para-toluene sulfonic acid (PTSA), strong acids, hydrochloric acid (HCl), sulfuric acid (H₂SO₄), any combination thereof, or any other organic or inorganic acid.

Following addition of the catalyst to the diluted input, the esterification reaction is then conducted. In various implementations, the reaction may take place at 70-90 C. In various implementations, the reaction vessel may be rated for positive pressure. In various implementations, the inputs may be reacted under high agitation. Where isopropanol is utilized as the solvent, the method may also include utilizing a condenser to recirculate the volatile isopropanol back into the reaction medium.

In various implementations, the esterification reaction may favor monoester formation over higher esters of the polyol (diesters, triesters, etc.). In some implementations, the degree of monoester conversion is dependent on the polyol and fatty acid/triglyceride molar ratio, reaction time, and the amount of catalyst. Depending on reaction parameters, total monoester content may range from about 30% to about 98% by weight of product. It has been observed that this reaction is not selective to specific types of polyols used as inputs and so can be used with a wide variety of polyols including monosaccharides and monomers such as, by non-limiting example, glycerol, polyglycerol, sorbitol, glucose, and any other polyol disclosed herein. In various implementations, the input can be, by non-limiting example, a wax ester, a fatty acid, oleic acid, cocoa butter, sunflower oil, hydrogenated sunflower oil, a triglyceride, a fully saturated triglyceride, a partially saturated triglyceride, a triglyceride unsaturated to varying degrees, any combination thereof, or any other fatty acid, triglyceride, ester, or combination thereof.

In various implementations, following the formation of the diluted input, the catalyst is added directly to the diluted input. For implementations utilizing an alkali catalyst (like sodium methoxide), when the catalyst is added to the polyol/isopropanol/oil phase (triglyceride/fatty acid) two liquid phase mixture, the esterification reaction may proceed slowly initially. As the reaction progresses, the addition of the alkali catalyst may form a small amount of fatty acid salts due to reaction with residual moisture present in either liquid phase, saponification of a component of the oil phase, and/or saponification of free fatty acids in the diluted input. Without being bound by any theory, the formation of the sodium soaps may allow the soap to act as a solubilizer between the two liquid phases of the polyol/isopropanol/oil phases. As the soaps form, it is observed that the mixture becomes a single liquid phase as all reactants become soluble in the same liquid phase. The formation of the single liquid phase speeds up the reaction rate and it is believed favors formation of monoester products as a result.

In various other implementations, following the formation of the diluted input, prior to adding the catalyst, a small amount of fatty acid salt/soap is added to form a prepared input. Following the formation of the prepared input, the catalyst is then added as previous described (which may be any catalyst type disclosed in this document). In particular implementations, the addition of fatty acid salt to the diluted input to form a mixture with a concentration of fatty acid salt of 250 ppm is sufficient. In other implementations, the addition of fatty acid salt at about 250 ppm to about 2500 ppm may be utilized. In various implementations, the fatty acid salt is sodium oleate, though in others, any fatty acid salt may be utilized, such as, by non-limiting example, fatty acid salts derived from the lipid input, fatty acid salts engineered to provide specific attributes to the final product, and any other fatty acid salt derived from fatty acids in the input or separately added. The cation of the fatty acid salt may include any alkali or alkaline earth metal ion, such as, by non-limiting example, sodium, potassium, magnesium, and calcium. It has been observed that adding a low concentration of fatty acid salt prior to acid catalyst addition unexpectedly substantially increased rate of the reaction in a solution where isopropanol was used as the solvent without the formation of isopropyl esters in contrast with what was observed with the base-only catalyzed procedure previously described. This result was completely unexpected. Without being bound by any theory, it is believed the mechanism facilitating the substantial increase in reaction in isopropanol is related to competition between simultaneously occurring SN1 and SN2 mechanisms in the (trans)esterification. Where the reaction is base catalyzed, the reaction is both occurring using SN1 and SN2 mechanisms simultaneously but involving different chemical species in the reaction mixture. Eventually, the slower SN1 reaction of isopropyl esters formed from the isopropanol (functionally non-reversible) overcomes the faster single step SN2 reaction (reversible) that is forming other esters. Where an acid catalyst is employed however, the reaction may proceed using a single reaction mechanism showing SN2 specificity which prevents the formation of substantial isopropyl esters by suppressing the SN1 mechanism. In either case, the addition of the fatty acid salt changes the specificity of the reaction when an acid catalyst is used, preventing the formation of isopropyl esters. The effect of adding the fatty acid salt may include the following results: low or no color increase throughout the reaction, low or no reversion or over-reaction, use of cheaper isopropanol over t-butanol is enabled, low or no formation of substantial quantities of isopropanol esters is observed, and use of free fatty acids as a lipid feedstock. In some implementations, the free fatty acids may be distillate from a deodorizer process.

In various other implementations, following the formation of the diluted input, prior to adding the catalyst, a small amount of base is added to form a prepared input where the inputs to the process are a polyol and a fatty acid. The effect of the small amount of base is that a small amount of fatty acid salt is formed (at a concentration of about 250 ppm in various implementations). Following the formation of the prepared input, the catalyst is then added as previous described (which may be any acid catalyst type disclosed in this document). In particular implementations, the formation at a concentration of about 250 ppm of fatty acid salt to the diluted input using the addition of the base is sufficient. In other implementations, the formation of about 250 ppm to about 2500 ppm may be utilized. In various implementations, the base is sodium hydroxide, though in others, any base may be utilized, such as, by non-limiting example, calcium carbonates, sodium carbonates, potassium hydroxide, and any other base. It has been observed that forming the low concentration of fatty acid salt prior to an acid catalyst addition unexpectedly substantially increased rate of the reaction in a solution where isopropanol was used as the solvent without the formation of isopropyl esters in contrast with what was observed with the base-only catalyzed procedure previously described. Again, this result was completely unexpected. Without being bound by any theory it is believed the mechanism facilitating the substantial increase in reaction in isopropanol is related to competition between simultaneously occurring SN1 and SN2 mechanisms similar to that previously described.

Following the catalytic esterification reaction, the reaction may then be neutralized with an acid such as, by non-limiting example, carbon dioxide, hydrochloric acid, citric acid, an acid, or any combination thereof. Neutralization with carbon dioxide may be particularly effective as in the process of doing so, the mixture forms a carbonate that precipitates out of solution and can easily be recovered from the polyol phase via filtration, leaving a recovered polyol of high purity suitable for subsequent reactions. The remaining isopropanol solvent may then be separated and recovered for use in additional batches. Excess polyol may then be subsequently removed via decantation and recovered for subsequent reaction. The remaining concentrated monoester oil phase may then be filtered to remove excess particulates such as fatty acid salts and carbonates.

Various examples of processes for forming esters from polyols are described herein solely for the exemplary purposes of this disclosure. Many process variations may be constructed for various esterification and transesterification processes involving polyols using the principles disclosed herein.

### Example 1—Polyglycerol 3, t-Butanol, Sodium Methoxide, Cocoa Butter

A polyglyceryl-3 ester of high monoester content was produced by adding 210.1 g of polyglycerol-3 and 250.0 g of refined cocoa butter in a 3:1 molar ratio and combining in a 1000 mL reaction flask with temperature, pressure, nitrogen, and agitation controls. The material was heated to 90 C and vacuum dried with a nitrogen sparge until moisture content by Karl Fischer analysis reached <0.02% by weight of solution. Once dry, 115.0 g of t-butanol was added as a solvent diluent (20% of total batch size by weight) and temperature was lowered to 70 C. Once the t-butanol was dispersed, 2.4 g of sodium methoxide catalyst was slowly added (1% of oil input by weight) and allowed to react. Shortly after the addition of sodium methoxide, the reaction matrix became single phase and transparent, indicating the reaction was active.

After 90 minutes, a sample was taken and analyzed using reverse phase high pressure liquid chromatography (RP-HPLC) using an Agilent (Santa Clara, Calif.) 1260 infinity HPLC system with Agilent 1290 ELSD. The method consisted of a gradient of 95/5% Acetonitrile/Ethyl Acetate to 5/95% through a 100 mm C₁₈ silica column over 10 minutes at 3 mL/min as the eluent. The product was found to have a 91% monoester content, 7% diester content, 2% triester content, and 2.7% methyl esters (all by weight of product). No butyl esters were detected. The reaction was neutralized with anhydrous citric acid, desolventized to remove the t-butanol, and filtered. A decantation step was not required as all the polyglycerol-3 had been consumed [the residual polyol would have shown a peak at a retention time (RT) of 0.9 min if present but was not observed].

### Example 2—Polyglycerol-3, Isopropanol, Sodium Methoxide, Cocoa Butter

Another reaction was conducted using the same procedure as in Example 1 with 197.8 g polyglycerol-3 and 282.2 g cocoa butter at a 2.5:1 molar ratio. The solvent was isopropanol instead of t-butanol and the reaction was then conducted under the same conditions and procedures including the same catalyst. Following analysis using the same chromatograph and analysis procedures as in Example 1, the monoester content was 72.0%, 11.2% diester, 2.6% triester, 6.4% methyl ester, and 7.5% isopropyl esters (all by weight of product). Residual polyglycerol-3 would typically elute at 0.9 minutes.

### Example 3—Glycerol, Isopropanol, Sodium Methoxide

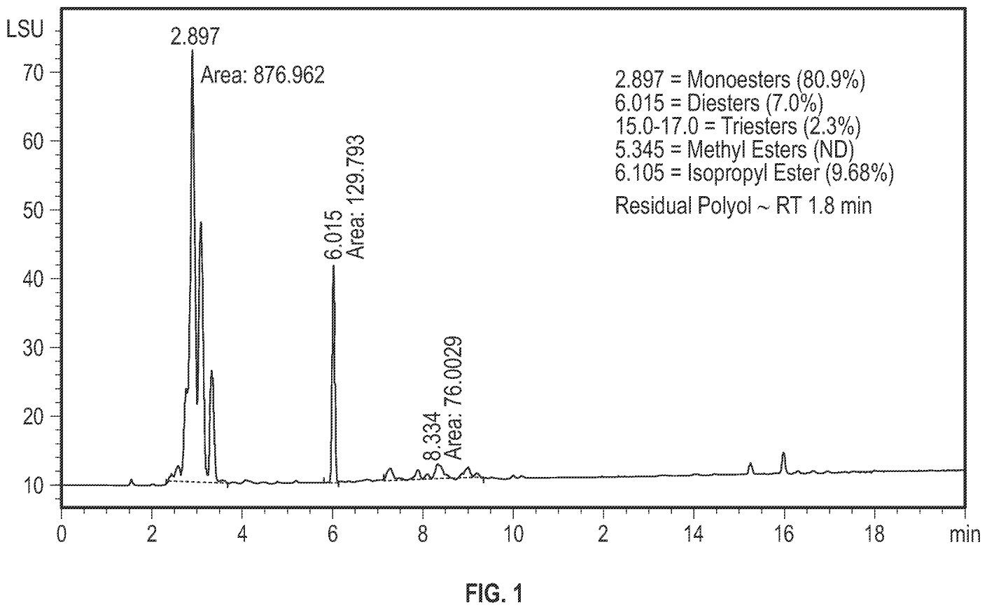

Another reaction was conducted using the procedures and equipment of Examples 1 and 2 with inputs of 117.03 g glycerol and 362.97 g cocoa butter at a 3:1 molar ratio. Isopropanol was used as the solvent as in Example 2 and the reaction was conducted under the same reaction conditions and procedures using the same catalyst. The monoester content was 80.9%, 6.0% diester, 2.3% triester, 0% methyl ester, and 9.68% isopropyl esters (by weight of the resulting product) as illustrated in the chromatograph of FIG. 1. As can be seen from inspection, almost no residual glycerol was observed at an RT of 1.8 so almost all the glycerol was consumed during the reaction.

### Example 4—Glycerol, Isopropanol, Para-Toluene Sulfonic Acid (PTSA)

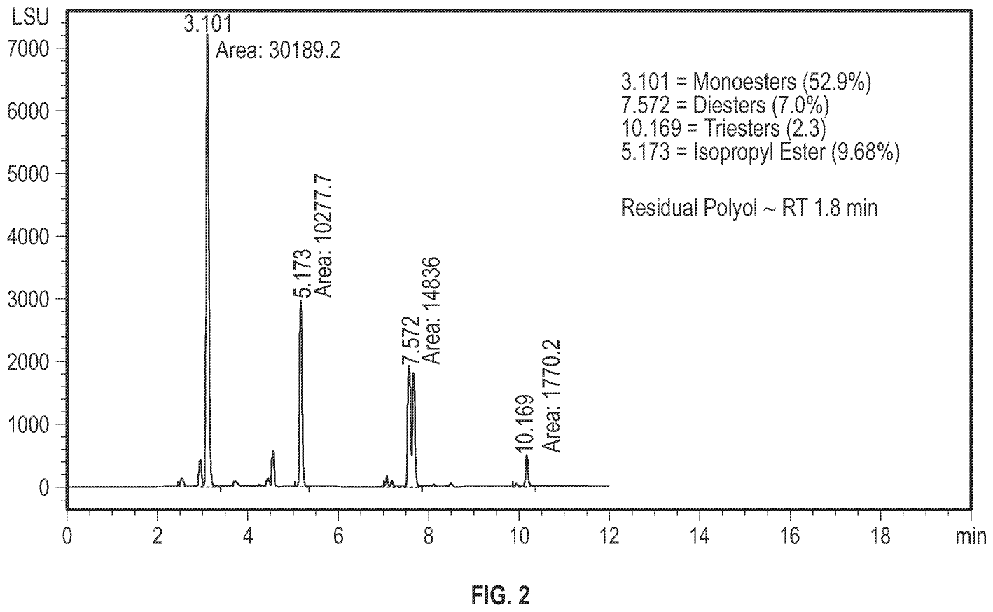

Another experiment was conducted using the procedures of Example 1 with inputs of 84.92 g glycerol and 395.08 g hydrogenated sunflower oil as a triglyceride source at a 2:1 molar ratio. Isopropanol was used as the solvent diluent and following addition of the isopropanol, para-toluene sulfonic acid was substituted for sodium methoxide at 0.1% by weight and neutralized with 50% NaOH solution (weight percent) when reaction was complete. The monoester content was 52.9%, 25.99% diester, 3.1% triester, 0% methyl ester, and 18.0% isopropyl esters as illustrated in the chromatograph of FIG. 2 (all by weight of product). The graph indicates that essentially no glycerol remained after the reaction at an RT of 1.8 min.

### Example 5—Polyglycerol-3, Isopropanol, PTSA

Another experiment was conducted using the procedures of Example 4 with 172.5 g polyglycerol-3 and 307.5 g hydrogenated sunflower oil in a 2:1 molar ratio as inputs. The combined inputs were diluted using 120 g of isopropanol as the solvent. PTSA was dosed at 0.1% by weight and neutralized with 50% NaOH solution (by weight) when the esterification reaction was complete. The monoester content was 52.9%, 25.99% diester, 3.1% triester, 0% methyl ester, and 18.0% isopropyl esters (all by weight of product). No residual polyglycerol-3 was observed at an RT of 0.9.

### Example 6—Glycerol, Isopropanol, PTSA, Sodium Oleate

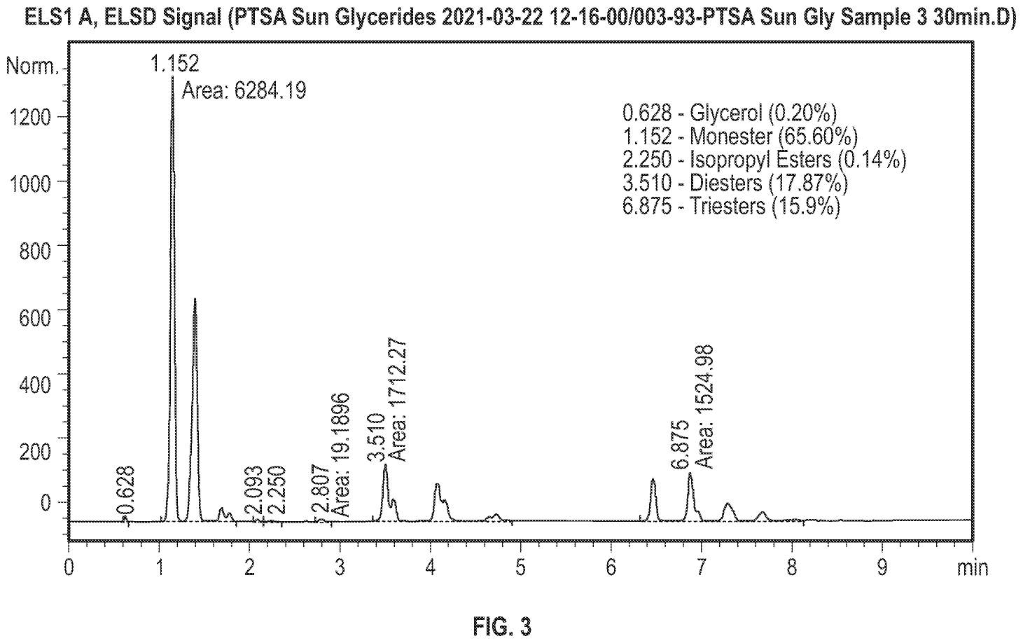

Another reaction was conducted using the procedures and equipment of Example 1 with 84.92 g glycerol and 395.08 g sunflower oil at a 2:1 molar ratio as inputs. The combined inputs were then diluted using isopropanol. Following the addition of isopropanol, 0.15 g of sodium oleate was added to the mixture to form a 250 ppm solution, turning the previous two-phase liquid into a single, transparent liquid phase. PTSA was then substituted for sodium methoxide at 0.1% by weight and neutralized with 50% NaOH solution (by weight) when reaction was complete. The monoester content was 65.6%, 17.9% diester, 6.9% triester, 0% methyl ester, and 0.14% isopropyl esters according to the chromatograph illustrated in FIG. 3 (by weight of product). It appeared that the addition of sodium oleate provided specificity for the PTSA acid catalyst, minimizing the amount of isopropyl esters and finding an equilibrium which maximized monoester formation. As illustrated in FIG. 3, the 2:1 molar ratio of polyol to sunflower oil was fully reacted to ideal stoichiometric completion, surprisingly indicating a very efficient reaction (no residual glycerol at an RT of 1.8 min was observed).

### Example 7—Glycerol, Isopropanol, PTSA, NaOH

Another reaction was conducted following the procedures of Example 4 using 84.92 g glycerol and 395.08 g sunflower oil as inputs in a 2:1 molar ratio. The mixed inputs were then combined with 20% isopropanol by weight. The diluted input then had 0.04% by weight of 50% NaOH (by weight) added to the mixture to saponify the sunflower oil form fatty acid sodium salts at a concentration of about 250 ppm along with corresponding partial glycerides. As with Example 6, the solution became a transparent single phase following the addition of the NaOH. PTSA was then added as the catalyst at 0.1% by weight and neutralized with 50% NaOH solution (by weight) when the reaction was complete. The monoester content was 66.7%, 17.9% diester, 6.9% triester, 0% methyl ester, and 0.14% isopropyl ester (all by weight of product). The addition of sodium oleate provided specificity for the acid catalyst, minimizing the amount of isopropyl esters and finding an equilibrium which maximized monoester formation. It was observed that the 2:1 molar ratio of polyol to sunflower oil was fully reacted to ideal stoichiometric completion, indicating a very efficient reaction. The initial addition of NaOH functionally behaved as a reaction seed, both forming fatty acid salts and partial glycerides at a concentration that was surprisingly observed to accelerate the reaction and improve conversion.

### Example 8—Glycerol, Isopropanol, PTSA, NaOH

A larger reaction was then conducted following the procedures of Example 7 with 195.7 g glycerol and 364.3 g sunflower oil as inputs at a 5:1 molar ratio. As in Example 7, the mixed inputs were combined with 20% isopropanol by weight. Following dilution with the solvent, 0.04% by weight of 50% NaOH (by weight) was added to the mixture to saponify the fatty acids in the sunflower oil to fatty acid sodium salts at a concentration of about 250 ppm along with corresponding partial glycerides. As with Example 7, the solution became a transparent single phase following addition of the NaOH. PTSA was then added at 0.1% by weight as a catalyst and neutralized with 50% NaOH solution (by weight) when the reaction was complete. The monoester content was 94.7%, 17.9% diester, 6.9% triester, 0% methyl ester, and 0.14% isopropyl esters by weight of product. The formation of sodium oleate via addition of the NaOH provided specificity for the acid catalyst, minimizing the number of isopropyl esters and reaching an equilibrium that maximized monoester formation. The 5:1 molar ratio of polyol to oil theoretically would produce 100% monoester due to substantial molar excess of polyol, which was observed to be reasonably achieved with a conversion of 94% monoester, 3.2% diester, 1.9% triester, and 0.1% isopropyl ester. The initial addition of NaOH functionally behaved as a reaction seed, both forming fatty acid salts and partial glycerides. Surprisingly, the excess glycerol was not regulated by mass-transfer limitations as with ordinary processes, effectively achieving ideal stoichiometric conversion to monoesters.

### Example 9—Polyglycerol-3, Isopropanol, PTSA, NaOH

A larger reaction was conducted following procedures of Example 5 with 280.2 polyglycerol-3 and 200 g sunflower oil as inputs at a 5:1 molar ratio. The mixed inputs were then combined with 20% isopropanol by weight as a diluent. Following addition of the isopropanol, 0.04% by weight of 50% NaOH solution (by weight) was added to the mixture to saponify the sunflower oil to form fatty acid sodium salts at a concentration of about 250 ppm along with corresponding partial glycerides. As with Example 6, the solution became a transparent single phase following the addition of the NaOH. PTSA was then added to the saponified mixture at 0.1% by weight as a catalyst and neutralized with 50% NaOH solution (by weight) when the reaction was complete. The monoester content was 93.1%, 4.8% diester, 2.0% triester, 0% methyl ester, and 0.1% isopropyl esters (all by weight of product). Again, the formation sodium oleate provided specificity for the acid catalyst, minimizing the number of isopropyl esters and reaching an equilibrium that maximized monoester formation. The 5:1 molar ratio of polyol to oil theoretically would produce 100% monoester due to substantial molar excess of polyol, which was observed to be reasonably achieved with a conversion of 94% monoester, 3.2% diester, 1.9% triester, and 0.1% isopropyl ester of the polyglycerol-3. The initial addition of NaOH functionally behaved as a reaction seed, both forming fatty acid salts and partially glycerol. Surprisingly, the reaction of the excess polyglycerol-3 was not regulated by mass-transfer limitations as with ordinary processes, effectively achieving ideal stoichiometric conversion.

### Example 10—Polyglycerol-3, Isopropanol, PTSA, NaOH, Oleic Acid

Another reaction was conducted using the procedures and equipment of Example 8 with 64.8 g polyglycerol-3 and 15.2 g oleic acid as inputs at a 5:1 molar ratio. The combined inputs were then diluted using 20% isopropanol by weight. The diluted inputs then had 0.04% by weight of 50% NaOH solution (by weight) added to the mixture to saponify the oleic acid to fatty acid sodium salts at a concentration of approximately 250 ppm. As with Example 7, the solution became a transparent single phase following addition of the NaOH. After addition of the NaOH, PTSA was then added at 0.1% by weight and neutralized with 50% NaOH solution (by weight) when the reaction was complete. In this example, the reaction vessel was set up with a Dean-Stark distillation apparatus to remove generated moisture from the esterification reaction while keeping the isopropanol in the reaction matrix. As moisture was removed, the reaction proceeded to a stoichiometric distribution of 97.2% monoester, 2.1% diester, 0.9% triester, and 0.1% isopropyl ester (by weight of product). Surprisingly, free fatty acids were not detectable by acid value or HPLC analysis, indicating all the oleic acid added was fully esterified.

### Example 11—Glycerol, Isopropanol, PTSA, NaOH, Oleic Acid

Another reaction was conducted using the equipment and procedures of Example 10 with 49.6 g glycerol and 30.4 g of oleic acid as inputs at a 5:1 molar ratio. The combined inputs were then diluted using 20% isopropanol by weight. Following dilution, 0.04% by weight of 50% NaOH solution (by weight) was added to the mixture to saponify the oleic acid to fatty acid sodium salts at a concentration of about 250 ppm. As with Example 7, the solution became a transparent single phase following addition of the NaOH. PTSA was then added at 0.1% by weight and neutralized with 50% NaOH solution (by weight) when the reaction was complete. As with Example 10, the reaction vessel was set up with a Dean-Stark distillation apparatus to remove generated moisture from the esterification reaction while keeping isopropanol in the reaction matrix. As moisture was removed, the reaction proceeded to a stoichiometric distribution of 97.5% monoester, 1.9% diester, 0.5% triester, and 0.1% isopropyl ester (by weight of product). Surprisingly, free fatty acids were not detectable by acid value or HPLC analysis, indicating all the oleic acid added was fully esterified.

### Example 12—Polyglycerol-3, t-Butanol, PTSA

Another reaction was conducted using the procedures of Example 1 with 210.1 g of polyglycerol-3 and 250.0 g of refined cocoa butter as inputs at a 3:1 molar ratio. The combined inputs were then diluted with 120 g of t-butanol. PTSA was dosed at 0.1% by weight as a catalyst and neutralized with 50% NaOH solution (by weight) when reaction was complete. The monoester content was 78.9%, 15.6% diester, 5.1% triester, and 0.39% methyl ester (all by weight of product). Residual polyglycerol-3 was observed in the chromatographic analysis at an RT of 0.9 min.

### Example 13—Polyglycerol-3, t-Butanol, PTSA, NaOH

Another reaction was conducted using the equipment and procedures of Example 12 with 210.1 g of polyglycerol-3 and 250.0 g of refined cocoa butter as inputs at a 3:1 molar ratio. The mixed inputs were then diluted with 120 g of t-butanol. The diluted input then had 0.04% by weight of 50% NaOH solution (by weight) to saponify the fatty acids in the cocoa butter to fatty acid sodium salts at a concentration of about 250 ppm. As with Example 12, the solution became a transparent single phase following addition of the NaOH. PTSA was then added at 0.10% by weight as a catalyst and neutralized with 50% NaOH solution when reaction was complete. The monoester content was 92.1%, 5.6% diester, 2.3% triester, and 0.1% isopropyl ester (all by weight of product). Surprisingly, the effect of creating the fatty acid sodium salts on the rate and conversion to monoesters of the reaction was still observed even when t-butanol was used as the solvent. No residual polyglycerol-3 was observed in the chromatographic analysis at an RT of 0.9 min.

### Example 14—Polyglycerol 3, Isopropanol, Sodium Methoxide (Large Scale)

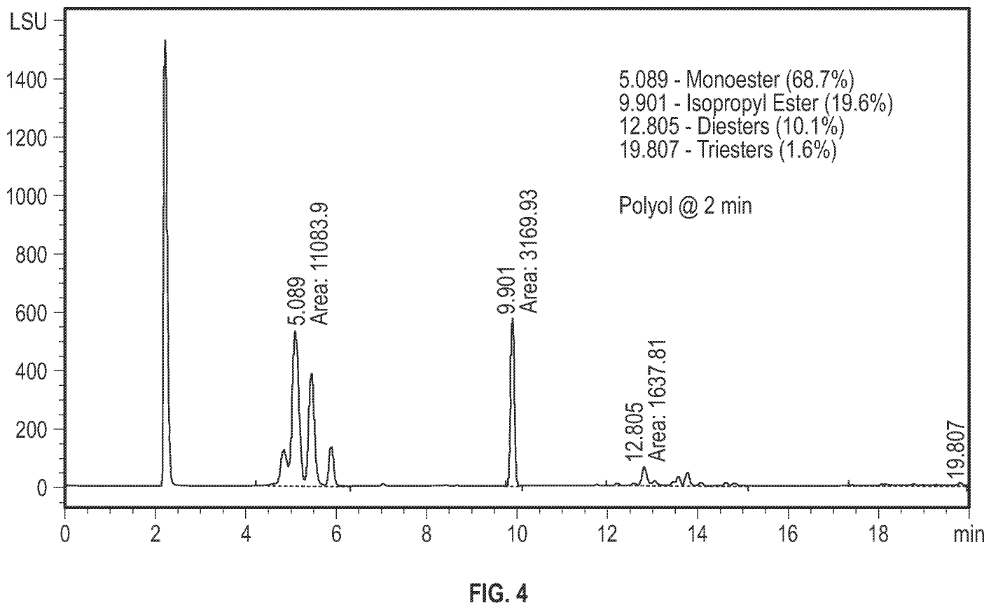

A large-scale reaction following the general procedures of Example 2 was conducted in a 1000 gallon jacketed stainless steel reactor. In the reactor 824 kg of polyglycerol and 1175.8 kg of hydrogenated sunflower oil at a 2.5:1 molar ratio were mixed and dried at 120 C using vacuum and nitrogen sparge until the moisture content via Karl Fischer analysis was <0.02% by weight. Following mixing of the inputs, 500 kg of isopropanol was added and mixed while the diluted mixture was cooled to 70 C. Sodium methoxide powder was then dosed as a catalyst into the reactor and the progress of the reaction monitored by RP-HPLC using ELSD until the observed monoglyceride/monoester content reached a maximum. The catalyst was then neutralized with 10% soft water by weight and subsequently removed along with the excess/unreacted glycerol/generated soaps. The remaining material was desolventized, filtered, and then formed into solid flakes for easier handling. The monoester content of the flakes was 68.7%, 10.1% diester, 1.6% triester, 0% methyl ester, and 19.6% isopropyl esters (all by weight of product) as shown in the chromatograph of FIG. 4.

### Example 15

In another experiment, the effects of the fatty acid salts solubilizing properties were further tested by adding 0.1% sodium stearate into a pre-reacted heterogeneous mixture of polyglycerol-3/isopropanol/hydrogenated sunflower oil at 80 C. The molar ratio of polyol to oil was 2.5 and the amount of isopropanol was 20% by weight of the polyol/oil input. After the solution was brought to temperature the multiple liquid phase system became a homogenous single phase prior to any catalyst addition. After catalyst addition, the reaction proceeded at a surprisingly higher rate than normally observed until the reaction reached 81% monoester conversion. In a follow-on experiment, the previous experiment was carried out using potassium stearate as the fatty acid salt and a single-phase solution was also obtained with surprisingly significant monoester conversion of 79%.

In places where the description above refers to particular implementations of processes and systems for forming fatty acid esters of polyols and implementing components, sub-components, methods and sub-methods, it should be readily apparent that a number of modifications may be made without departing from the spirit thereof and that these implementations, implementing components, sub-components, methods and sub-methods may be applied to other processes and systems for forming fatty acid esters of polyols.

What is claimed is:

1. A process forming esters of polyols comprising:
mixing a polyol with a triglyceride in a reactor at a 2.5-6:1 molar ratio of polyol to triglyceride to form an input;
mixing the input with isopropanol to form a diluted input;
mixing a catalyst with the diluted input; and
heating and agitating the diluted input to form a product comprising monoesters of the triglyceride and the polyol.

2. The process of claim 1, wherein the monoesters are between 30% to 95% by weight of the product.

3. The process of claim 1, wherein the catalyst is between 0.2% to 0.7% by weight of the diluted input.

4. The process of claim 1, wherein the catalyst is one of sodium methoxide, sodium hydroxide, potassium hydroxide, calcium carbonate, para-toluene sulfonic acid, hydrochloric acid, sulfuric acid, or any combination thereof.

5. The process of claim 1, further comprising forming a soap using the catalyst to solubilize the polyol, triglyceride, and isopropanol.

6. The process of claim 1, wherein the polyol is one of glycerol or a polyglycerol.

7. A process forming esters of polyols comprising:
mixing a polyol with a triglyceride in a reactor at a 2.5-6:1 molar ratio of polyol to triglyceride to form an input;
mixing the input with a solvent to form a diluted input;
mixing a fatty acid salt with the diluted input to form a prepared input
mixing a catalyst with the prepared input; and
heating and agitating the prepared input to form a product comprising monoesters of the triglyceride and the polyol.

8. The process of claim 7, wherein the monoesters are between 30% to 95% by weight of the product.

9. The process of claim 7, wherein the catalyst is between 0.2% to 0.7% by weight of the prepared input.

10. The process of claim 7, wherein the catalyst is one of sodium methoxide, sodium hydroxide, potassium hydroxide, calcium carbonate, para-toluene sulfonic acid, hydrochloric acid, sulfuric acid, or any combination thereof.

11. The process of claim 7, further comprising forming a soap using the catalyst to solubilize the polyol, triglyceride, and isopropanol.

12. The process of claim 7, wherein the polyol is glycerol or a polyglycerol.

13. The process of claim 7, wherein the fatty acid salt is sodium oleate and a concentration of the fatty acid salt in the prepared input is 250 ppm after mixing.

14. A process forming esters of polyols comprising:
mixing a polyol with a fatty acid in a reactor at a 2.5-6:1 molar ratio of polyol to fatty acid to form an input;
mixing the input with a solvent to form a diluted input;
mixing a base with the diluted input to form a saponified input;
mixing a catalyst with the saponified input; and
heating and agitating the saponified input to form a product comprising monoesters of the fatty acid and the polyol.

15. The process of claim 14, wherein the monoesters are between 30% to 95% by weight of the product.

16. The process of claim 14, wherein the catalyst is between 0.2% to 0.7% by weight of the saponified input.

17. The process of claim 14, wherein the catalyst is one of sodium methoxide, sodium hydroxide, potassium hydroxide, calcium carbonate, para-toluene sulfonic acid, hydrochloric acid, sulfuric acid, or any combination thereof.

18. The process of claim 14, wherein the polyol is glycerol or a polyglycerol.

19. The process of claim 14, wherein the base is sodium hydroxide and the concentration of a fatty acid salt in the saponified input is 250 ppm after mixing.

20. The process of claim 14, wherein mixing the polyol with the fatty acid further comprises mixing a triglyceride with the polyol and the fatty acid and wherein the product comprises monoesters of the fatty acid, the triglyceride, and the polyol.
